(19) United States
(12) Patent Application Publication
(10) Pub. No.: US 2001/0048486 A1
(43) Pub. Date: Dec. 6, 2001

(54) APPARATUS FOR DETECTION OF CUT IN COMPRESSED MOTION PICTURE DATA

(76) Inventors: TOSHIKAZU AKAMA, FUKUOKA-SHI (JP); KOJI ARIMURA, KASUYA-GUN (JP); JUN IKEDA, FUKUOKA-SHI (JP); YUKIKO INOUE, FUKUOKA-SHI (JP)

Correspondence Address: LAWRENCE E ASHERY, RATNER & PRESTIA, ONE WESTLAKES SUITE 301 BERWYN, P O BOX 980, VALLEY FORGE, PA, 194820980

(21) Appl. No.: 09/046,315

(22) Filed: Mar. 23, 1998

(30) Foreign Application Priority Data
Mar. 21, 1997 (JP) 9-067668
Nov. 28, 1997 (JP) 9-327401

(51) Int. Cl. H04N 7/12

(52) U.S. Cl. 348/700; 375/240.16

(57) ABSTRACT

An apparatus comprising a tape media compressed motion picture data reader for reading out compressed motion picture data from tape media, random access media, a compressed motion picture data transfer device for transferring compressed motion picture data from the tape media compressed motion picture data reader to the random access media, and a data comparator for comparing data between consecutive frames, whereby a frame accompanied by a scene change is detected by using the result of comparison.

### FIELD OF THE INVENTION

The present invention relates to a technology for detecting a frame accompanied by scene change (hereinafter called cut) efficiently from compressed motion picture data.

### BACKGROUND OF THE INVENTION

Recently, as represented by the DV camera, opportunities for handling compressed motion picture data are increasing in the video field. By detecting cuts from such compressed motion picture data, data search and editing job can be done efficiently. Supposing a continuous picture without any intermediate cut to be a video clip, the cut is the beginning image of the video clip and is a representative image. For example, in the case of nonlinear editing of a program supplied as compressed motion picture data by a personal computer or the like, a series of contents may be understood by preliminarily detecting cuts from the compressed motion picture data, and arranging and displaying the cuts. Also by linking the cut which is the representative image of the video clip and the position information of the cut, the sequence of video clips can be changed by changing the sequence of the cuts, so that the program can be edited easily.

A conventional apparatus for detection of cut in compressed motion picture data for detecting a cut from DV data is explained below. The DV data is an example of compressed motion picture data. The DV data conforms to the Specifications of Consumer-Use Digital VCRs using 6.3 mm magnetic tape at HD Digital VCR Conference First, the encoding method for DV and format are explained.

The encoding method for DV is described by referring to FIG. 19-a, b. In each frame of original picture, the luminance signal and color difference signal are divided into plural blocks of luminance (Y) and color difference (Cr, Cb) (horizontal 8 pixels vertical 8 pixels) as shown in FIG. 19-a.

In the following steps, detailed description accompanied by drawing is omitted, but thereafter six blocks combining four blocks of luminance (Y) signal and two blocks of color difference (Cr, Cb) signal form a macro block, and shuffling is done in the unit of macro block. Thereafter, in every macro block, data is compressed sequentially. In data compression, the signal of each block is processed by discrete cosine transform (DCT), and the obtained DCT coefficient is quantized and coded in variable length.

As a result, DCT coefficients composed of one DC component and sixty-three AC components are obtained in every block (FIG. 19-b).

In the DCT, two modes are prepared, that is, 8-8 DCT and 2-4-8 DCT, which are used adaptively depending on the amount of the image change between corresponding two fields. These two modes are used by changing over appropriately by the one-bit code called flag of DCT mode. When the motion of the subject is fast, that is, in the case of a large difference in values of pixels of two corresponding blocks of odd field and even field in a same frame, the value of the flag indicating the DCT mode is 1, and the 2-4-8 DCT is performed. In the case of a slow motion such as still picture, that is, in the case of a small difference in values of pixels of two corresponding blocks of odd field and even field in a same frame, the value of the flag indicating the DCT mode is 0, and the 8-8 DCT is performed.

The AC component of DCT coefficient is divided into four areas, area 0 to area 3 as shown in FIG. 19-b, and each area is quantized individually. The quantization step for quantizing each area is determined by the class number and quantization number mentioned later. The quantized AC component is compressed by variable length coding.

Each area is divided into four classes, class 0 to class 3, by the magnitude of the maximum value of the absolute value of AC component of each area. The class number is intended to distinguish each class.

FIG. 20-a shows an example of relation between the maximum value of absolute value of AC component and class number. The quantization number is a value for limiting the quantity of data after compression.

FIG. 20-b is a table for determining the quantization step. The relation between class number, quantization number, each area (area numbers 0 to 3) and quantization step is as shown in FIG. 20-b.

The quantization step is the numerical value enclosed by thick line in the lower right corner in FIG. 20-b, and by designating the class number and quantization number, the quantization step of each area is determined.

Referring now to FIG. 21-a and 21-b, FIG. 22, FIG. 23, and FIG. 24, the format of DV data is explained, that is, the format formed as continuous data by multiplexing the video signal compressed in the above process, the audio signal not mentioned herein and the additional codes represented by time code mentioned later. In the following example, a case of NTSC is described.

A logical format is converted to a recording format after several steps of processes and then recorded on tape of VCR. Therefore, hereinafter a position of data in a logical format is called as a recording position and a region for certain data in a logical format is also call a recording region.

FIG. 21-a and 21-b show respectively compressed luminance block and compressed color difference block. As shown herein, data of luminance block is composed of 14 bytes, and color difference block is 10 bytes. The DC component is fixed at 9 bits, the class number is fixed at 2 bits, and the flag of DCT mode is fixed at 1 bit, which are recorded in the determined positions as shown in FIG. 21-a and 21-b. The recording region of AC component is fixed at 100 bits in the case of luminance block, and 68 bits in the case of color difference block, but since the data of AC component recorded in the recording region is compressed by variable length coding, the size of range of recording in the recording region depends on the complexity s of with the picture.

FIG. 22 shows a composition of a compressed macro block. The compressed macro block is composed of four compressed luminance (Y) blocks, and two compressed color difference (Cr, Cb) blocks. The quantization number used in quantization of AC component of DCT coefficient is fixed at 4 bits, and is set in each macro block and recorded in the position as shown in FIG. 22.

FIG. 23 shows a format composition of DV data which is the compressed motion picture data for one frame. Each frame is composed of ten DIF sequences. Each DIF sequence is composed of is 150 (No. 0 to No. 149 in FIG. 23) DIF blocks. In No. 0 to No. 5 DIF blocks, various information about the frame is recorded. They include the index code used as the marker for searching the beginning of a desired scene, and time code showing the date and time of shooting by DV camera. In the index code, the marker may be recorded every time recording is started, or the marker may be freely recorded as a desired position of the user regardless of the recording starting position.

In No. 6 to No. 149 DIF blocks, compressed audio data and video data are recorded.

In the following description, the audio data is not important, and hence the data recorded in No. 6 to No. 149 DIF blocks are called the encoded video data, and the corresponding blocks are called video data block, so as to be distinguished from No. 0 to No. 5 DIF blocks. Further, the decoded data of such encoded video data are called decoded video data.

Since the size of each DIF block is fixed at 80 bytes, the size of the entire frame is fixed at 120 k bytes.

FIG. 24 shows the composition of one DIF sequence. In FIG. 24, A0 to A8 are DIF blocks of audio data, and V0 to V134 are DIF blocks of video data. In each DIF block from V0 to V134, information of one macro block is recorded.

Generally, data of large capacity, such as data shot by DV camera, and data digitized existing analog motion picture and encoded to DV data format are often recorded in more inexpensive tape media than the hard disk or the like.

In the case of nonlinear editing of such DV data by a personal computer, it is necessary to transfer the DV data from the tape media to random access media such as hard disk on the personal computer.

In a conventional example of apparatus for detection of cut in compressed motion picture data, the cut is detected when transferring DV data from the tape media to the personal computer. Such conventional apparatus for detection of cut in compressed motion picture data is described below.

FIG. 25 shows its composition. In FIG. 25, reference numeral 100 is a tape media for DV in which the DV data is recorded, 101 is a VCR for DV for reading out DV data from the tape media for DV 100, and 102 is a personal computer. Reference numeral 103 is an IEEE1394 cable for transferring DV data from the VCR for DV 101 to the personal computer 102.

Inside of the personal computer 102, reference numeral 118 is a memory, that is, fourth random access media for temporarily storing data of one frame out of DV data entered through IEEE1394 cable 103, 107 is the hard disk, which is the second random access media, and 119 is cut judging means. This cut judging means reads out the index code from each DIF sequence of DV data of one frame stored in the memory 118, judges presence or absence of cut from the value of index code, and sends the frame number of the cut to the hard disk 107.

In this structure, the cut judging means 119 is composed of software.

FIG. 26 shows the flow of operation of the conventional apparatus for detection of cut in compressed motion picture data. The operation of the conventional apparatus for detection of cut in compressed motion picture data is described below while referring to FIG. 25 and FIG. 26.

DV data of one frame is read out from the tape media for DV 100, and is stored in the memory 118 in the personal computer 102 through the IEEE1394 cable 103 (S1 in FIG. 26).

At this time, the frame number variable is increased by the cut judging means 119 (S2 in FIG. 26). Consequently, the index code is read out from the data stored in the memory 118, and it is checked if a marker of cut is recorded or not in the index code, and the presence or absence of cut is judged (S3 in FIG. 26).

Depending on the specification of the DV camera, the marker of cut is automatically recorded in the index code upon every start of recording. In the DV data shot by such DV camera, the cut can be detected correctly.

If not judged as cut, the DV data of the present frame stored in the memory 118 is transferred to the hard disk 107, and recorded (S5 in FIG. 26).

If presence of cut is judged, the frame number of the frame is transferred to the text file on the hard disk 107 (S4 in FIG. 26).

The DV data of the present frame stored in the memory 118 is transferred and recorded in the hard disk 107 (S5 in FIG. 26).

This process is repeated up to the final frame.(S6 in FIG. 26)

Thus, in the conventional apparatus for detection of cut in compressed motion picture data, the cut was detected by referring to the index code recorded in the DV data when shooting by the DV camera.

In the conventional apparatus for detection of cut in compressed motion picture data, however, since the cut is detected by referring to the index code recorded in the DV data when shooting by the DV camera, the cut could not be detected in the DV data in which the marker of index code is not provided when starting recording.

For example, when the analog motion picture data having already many cuts is recorded by the VCR for DV, the cuts in the motion picture data and the index codes do not correspond to each other. Hence, the cut cannot be detected by using the index code.

And then, if it is unknown how the DV data is created, that is, if it is not known that the DV data is taken and recorded by which DV camera or dubbed and recorded by which VCR for DV, it cannot be confirmed whether the index codes and cuts correspond to each other or not, and the result of cut detection by using the index code is not reliable.

### SUMMARY OF THE INVENTION

A first apparatus for detection of cut in compressed motion picture data comprises tape media compressed motion picture data reading means for reading out compressed motion picture data from tape media, first random access media for temporarily storing compressed motion picture data read out by the reading means, compressed motion picture data transfer means for transferring compressed motion picture data from the tape media compressed motion picture data reading means to the first random access media, and means for judging presence or absence of cut by comparing recorded time codes of two consecutive frames in the compressed motion picture data recorded in the first random access media.

A second apparatus for detection of cut in compressed motion picture data comprises tape media compressed motion picture data reading means for reading out compressed motion picture data from tape media, first random access media for temporarily storing compressed motion picture data read out by the reading means, compressed motion picture data transfer means for transferring compressed motion picture data from the tape media compressed motion picture data reading means to the first random access media, decoding means for decoding the compressed motion picture data of plural frames stored in the first random access media, third random access media for storing the decoded video data, decoded video data comparing means for comparing the decoded video data of plural frames stored in the third random access media, and means for judging presence or absence of cut by using the result of comparison of values of pixels obtained by the decoded video data comparing means.

A third apparatus for detection of cut in compressed motion picture data comprises specific position data comparing means for comparing data of specific position counting from the beginning of each frame of encoded video data and between frames, and means for judging presence or absence of cut by using the result of comparison of the specific position data comparing means. The specific position data include values of DC components of discrete cosine transform coefficients, class numbers determined by the value of AC components, quantization number, and quantization step. Moreover, results of these comparisons may be used in combination.

A fourth apparatus for detection of cut in compressed motion picture data comprises a DCT mode counter for counting the number of blocks having the DCT mode used when the difference value of pixel values between fields is large, and means for judging presence or absence of cut by using the result of counting.

### BRIEF DESCRIPTION OF THE DRAWINGS

FIG. 1 is a structural diagram of an apparatus for detection of cut in compressed motion picture data in a first embodiment of the invention.

FIG. 2 is a chart showing flow of operation of the apparatus for detection of cut in compressed motion picture data in the first embodiment of the invention.

FIG. 3 is a structural diagram of an apparatus for detection of cut in compressed motion picture data in a second embodiment of the invention.

FIG. 4 is a chart showing flow of operation of the apparatus for detection of cut in compressed motion picture data in the second embodiment of the invention.

FIG. 5-a is a picture showing original picture for explaining the calculating method of change amount of luminance signal in the second embodiment of the invention.

FIG. 5-b is a picture showing region division for explaining the calculating method of change amount of luminance signal in the second embodiment of the invention.

FIG. 5-c is a picture showing original picture for explaining the calculating method of change amount of luminance signal in the second embodiment of the invention.

FIG. 5-d is a picture showing region division for explaining the calculating method of change amount of luminance signal in the second embodiment of the invention.

FIG. 6 is a graph showing an example of change amount of luminance signal in the second embodiment of the invention.

FIG. 7 is a structural diagram of an apparatus for detection of cut in compressed motion picture data in a third embodiment of the invention.

FIG. 8 is a chart showing flow of operation processing of the apparatus for detection of cut in compressed motion picture data in the third embodiment of the invention.

FIG. 9 is a structural diagram of an apparatus for detection of cut in compressed motion picture data in a fourth embodiment of the invention.

FIG. 10 is a chart showing flow of operation processing of the apparatus for detection of cut in compressed motion picture data in the fourth embodiment of the invention.

FIG. 11-a is a picture showing original picture for explaining the relation of image and class number in the fourth embodiment of the invention.

FIG. 11-b is a picture showing a larger portion of class number in FIG. 11-a in the fourth embodiment of the invention.

FIG. 12-a is a picture showing original picture for explaining the method of determining change amount of class number in the fourth embodiment of the invention.

FIG. 12-b is a picture for explaining the class number in the fourth embodiment of the invention.

FIG. 12-c is a picture showing original picture for explaining an example of method of determining change amount of class number in the fourth embodiment of the invention.

FIG. 12-d is a picture for explaining the class number in the fourth embodiment of the invention.

FIG. 13 is a diagram showing an example of change amount of class number in the fourth embodiment of the invention.

FIG. 14 is a structural diagram of an apparatus for detection of cut in compressed motion picture data in a fifth embodiment of the invention.

FIG. 15 is a chart showing flow of operation of the apparatus for detection of cut in compressed motion picture data in the fifth embodiment of the invention.

FIG. 16-a is a picture showing original picture in which the subject is immobile in the fifth embodiment of the invention.

FIG. 16-b a picture showing a mobile case of the subject in the fifth embodiment of the invention.

FIG. 16-c is a picture for explaining the DCT mode in a mobile case of subject in the fifth embodiment of the invention.

FIG. 17 is a picture showing an example of correspondence between image and DCT mode of field mixture cut in the fifth embodiment of the invention.

FIG. 18 is a graph showing an example of number of blocks where the DCT mode in each frame is one, in the fifth embodiment of the invention.

FIG. 19-a is a picture of original picture for explaining compressing method of each block of DV data.

FIG. 19-b is a drawing for explaining DCT block of DV.

FIG. 20-a is a table showing an example of relation between the maximum value of absolute value of AC component and class number.

FIG. 20-b is a table for determining the quantization step.

FIG. 21-a is an explanatory diagram of data configuration of compressed data of luminance block in DV data.

FIG. 21-b is an explanatory diagram of data configuration of compressed data of color difference block in DV data.

FIG. 22 is an explanatory diagram of composition of compressed data of macro block of DV data.

FIG. 23 is an explanatory diagram of composition of data of one frame of DV data.

FIG. 24 is an explanatory diagram of composition of one DIF sequence data of DV data.

FIG. 25 is a structural diagram of an apparatus for detection of cut in compressed motion picture data in a prior art.

FIG. 26 is a flow chart of processing in the conventional apparatus for detection of cut in compressed motion picture data.

### DETAILED DESCRIPTION OF THE INVENTION

(Embodiment 1)

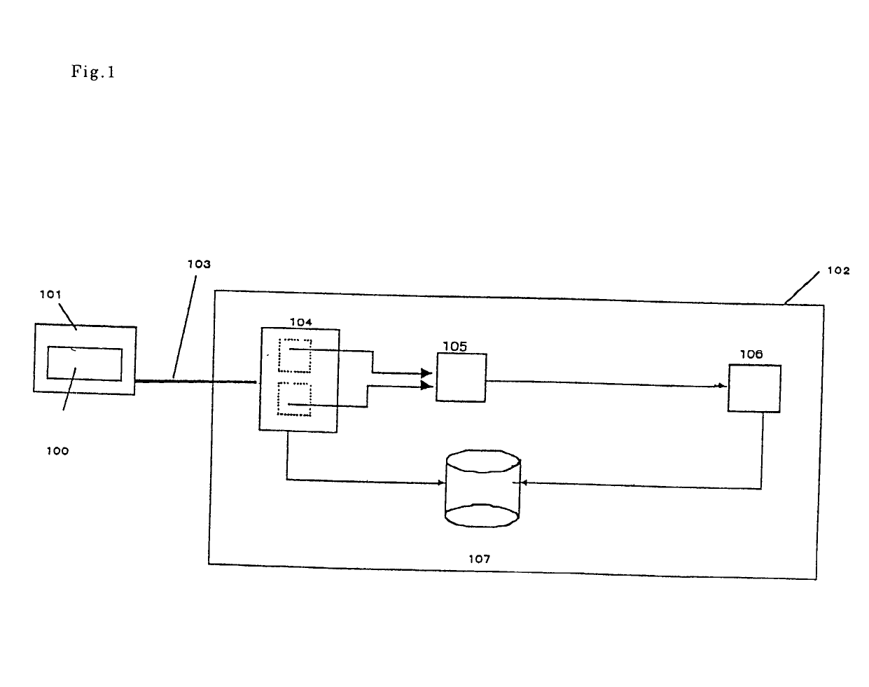

FIG. 1 is a structural diagram of an apparatus for detection of cut in compressed motion picture data in a first embodiment of the invention. In FIG. 1, reference numeral 100 is tape media for DV in which DV data is recorded, 101 is a VCR for DV as tape media compressed motion picture data reading means for reading out DV data from the tape media for DV 100, and 102 is a personal computer. Reference numeral 103 is an IEEE1394 cable for transferring DV data from the VCR for DV 101 to the personal computer 102.

Inside of the personal computer 102, reference numeral 104 is a memory, which is first random access media for temporarily storing DV data for two frames (present frame and preceding frame) out of the DV data entered through the IEEE1394 cable 103. Reference numeral 107 is the hard disk, which is the second random access memory, 105 is recorded time code comparing means for reading out and comparing the recorded time codes from each frame of DV data of two frames recorded in the first random access media 104, and 106 is cut judging means for controlling the frame numbers of DV data temporarily stored in the memory 104, judging presence or absence of cut from the result of the recorded time code comparing means 105, and transferring the frame number of the cut to the hard disk 107.

In this embodiment 1, the recorded time code comparing means 105 and cut judging means 106 are composed of software.

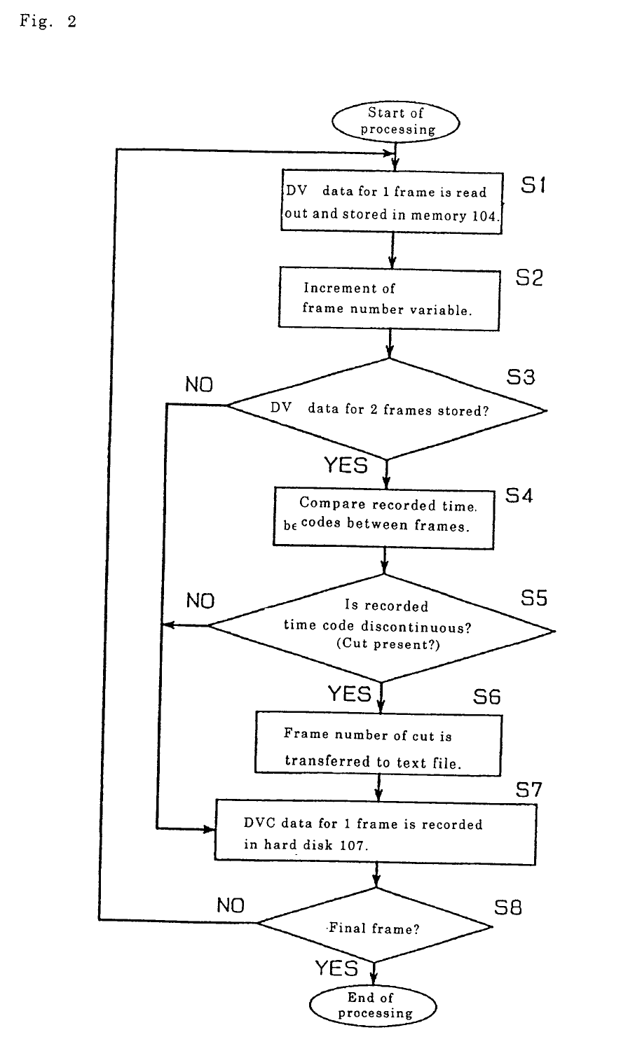

FIG. 2 shows the flow of operation of the apparatus for detection of cut in compressed motion picture data in embodiment 1 of the invention. The operation of the apparatus for detection of cut in compressed motion picture data in embodiment 1 of the invention is described below while referring to FIG. 1 and FIG. 2.

DV data for one frame is read out from the tape media for DV 100 in FIG. 1, and is stored as DV data of present frame in the memory 104 in the personal computer 102 through the IEEE1394 cable 103 (S1 in FIG. 2).

At this time, the cut judging means 106 increases the frame number variable by one(S2 in FIG. 2). Judging whether DV data of two frames, that is, the present frame and preceding frame, are stored in the memory 104 or not (S3 in FIG. 2), when the DV data for two frames are stored, the recorded time codes of two frames are compared (S4 in FIG. 2). Herein, the recorded time code refers to the code corresponding to the date and time of recording. Therefore, after once stopping the recording, when recording is resumed, the recorded time code becomes discontinuous. When the value of the recorded time code is discontinuous, it is judged that a cut is present (S5 in FIG. 2), and the frame number is transferred to the text file on the hard disk 107 (S6 in FIG. 2).

Next, the DV data of the present frame stored in the memory 104 is transferred and recorded in the hard disk 107 (S7 in FIG. 2). If the recorded time code is not discontinuous, the DV data of the present frame stored in the first random access media 104 is stored in the hard disk 107 (S7 in FIG. 2).

This process is repeated up to the final frame(S8 in FIG. 2).

Thus, by using the time code recorded in the DV data when shooting by the DV camera, cuts can be detected. By using the structure as shown in FIG. 1, regardless of the recorded content of the index code, simultaneous processing of transfer of the compressed motion picture data from the tape media 100 to the personal computer 102, and cut detection are realized. Incidentally, since the compressed motion picture data is smaller in data quantity as compared with non-compressed motion picture data, simultaneous processing of data transfer and cut detection can be realized at higher speed.

Moreover, by simultaneous processing of data transfer and cut detection, when data transfer to the personal computer is over, the user can immediately start next job such as nonlinear editing. At this time, by referring to the frame number of the cut recorded already in the text file, an arbitrary video clip can be accessed randomly for reproduction, or the sequence of video clips can be changed.

(Embodiment 2)

A second embodiment of the invention is described below while referring to the drawings.

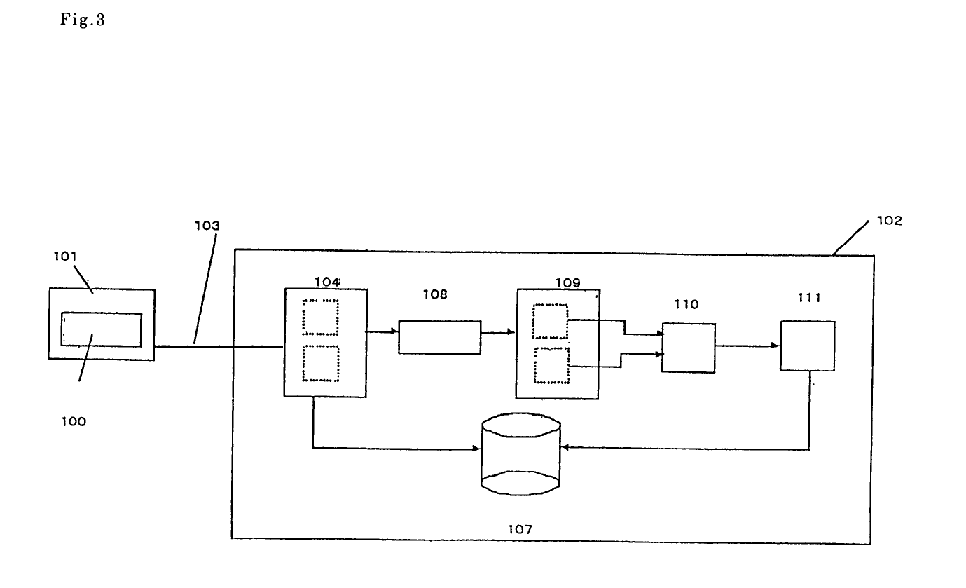

FIG. 3 is a structural diagram of an apparatus for detection of cut in compressed motion picture data in embodiment 2 of the invention. In FIG. 3, reference numeral 108 is decoding means for decoding the DV data stored in the memory 104 and reproducing the image data, and 109 is a memory for storing decoded video data for two frames, which is called third random access media. Reference numeral 110 is decoded video data comparing means for comparing digital values of pixels of luminance signal or color difference signal of two frames stored in the third random access media 109 which is the decoded video data memory, and 111 is cut judging means for controlling the frame numbers of DV data stored in the memory 104, detecting the cut by using the result of the decoded video data comparing means 110, and transferring the frame number of the cut to the hard disk 107. Description of same reference numerals as in FIG. 1 is omitted.

In this embodiment 2, for example, the decoded video data comparing means 110 and cut judging means 111 are composed of the software.

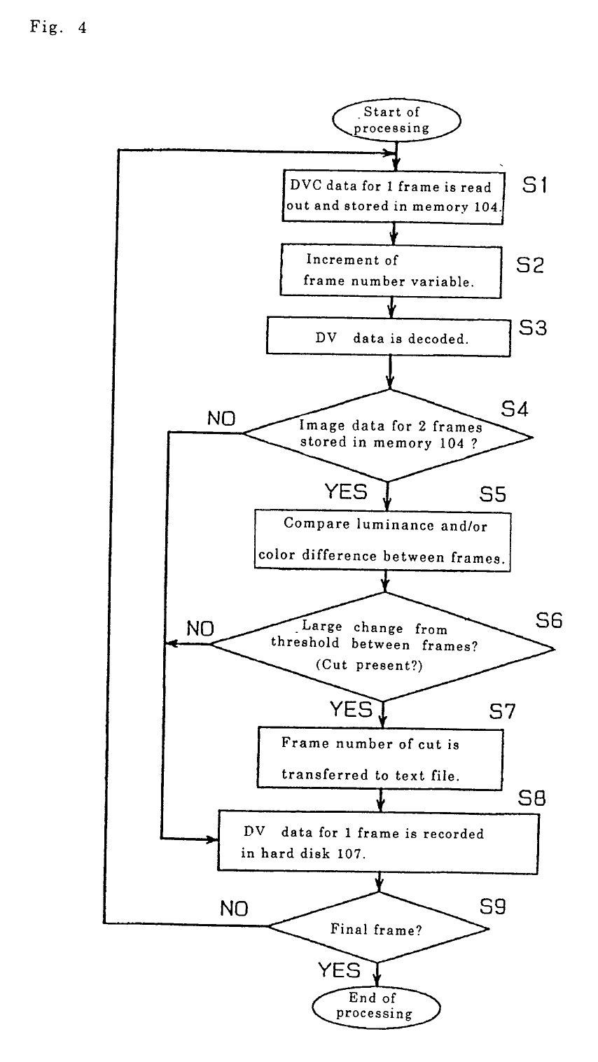

FIG. 4 shows the flow of operation of the apparatus for detection of cut in compressed motion picture data in embodiment 2 of the invention. The operation of the apparatus for detection of cut in compressed motion picture data in embodiment 2 of the invention is described below while referring to FIG. 3 and FIG. 4.

DV data for one frame is read out from the tape media for DV 100, and is stored as DV data of present frame in the memory 104 in the personal computer 102 through the IEEE1394 cable 103 (S1 in FIG. 4).

At this time, the cut judging means 111 increases the frame number variable by one(S2 in FIG. 4). The DV data stored in the memory 104 is decoded by the decoding means 108, and reproduced into motion picture data, and the reproduced decoded video data is stored in the decoded video data memory 109 (S3 in FIG. 4).

Judging whether decoded video data of two frames, that is, the present frame and preceding frame, are stored in the decoded video data memory 109 or not (S4 in FIG. 4), when the DV data of only one frame is stored in the memory 104, the DV data is recorded in the hard disk 107 (S8 in FIG. 4).

When video data for two frames are stored, the luminance signals or color difference signals of two frames are compared (S5 in FIG. 4). When the change amount of luminance signals or color difference signals is larger than a predetermined threshold, it is judged that a cut is present, and when the change amount of luminance signals or color difference signals is smaller than the threshold, it is judged that a cut is absent (S6 in FIG. 4).

When judged that cut is absent, the DV data of the present frame is recorded in the hard disk 107 (S8 in FIG. 4).

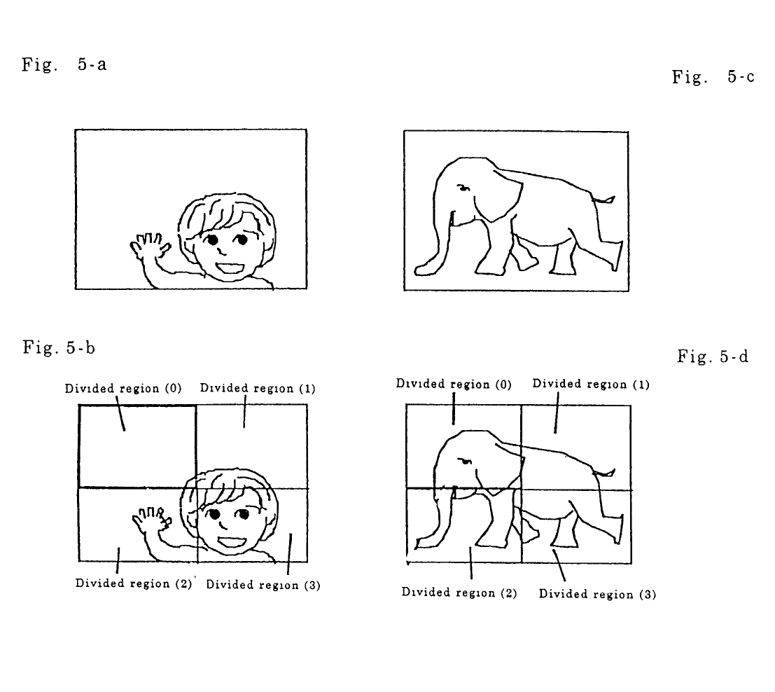

Examples of calculating the change amount of luminance signals are shown in FIG. 5-a, FIG. 5-b, FIG. 5-c, and FIG. 5-d. The original pictures shown in FIG. 5-a and FIG. 5-c are divided as shown in FIG. 5-b and FIG. 5-d, and the difference of values of corresponding pixels of the preceding frame and present frame is determined, and the sum of differences is determined in each divided region, which is obtained as the difference of each divided region. Consequently, the sum of absolute values of differences of all divided regions is determined, which is obtained as the change amount of the luminance signals.

When the change amount of the luminance is larger than a predetermined threshold, it is judged that a cut is present.

In the above description, the sum of absolute values of differences of all divided regions is determined, after dividing a frame into several regions, and said sum makes the difference between frames. That is a purpose to emphasize a individual change of each region between frames.

It is also another way that differences of all pixels through a frame are summed and the absolute value of said summed value makes a difference between frames, without any dividing a frame.

However, in this cut, when a big building is in a right half of a scene in a preceding frame and a similar building is in a left half of a scene in the present frame, a sum of differences of all pixels between the present frame and the preceding frame is small, and it is hard to detect cut at the point between the present frame and the preceding frame. To avoid such a problem, it is important to emphasize a difference of each divided region between two frames, after dividing a frame into several regions.

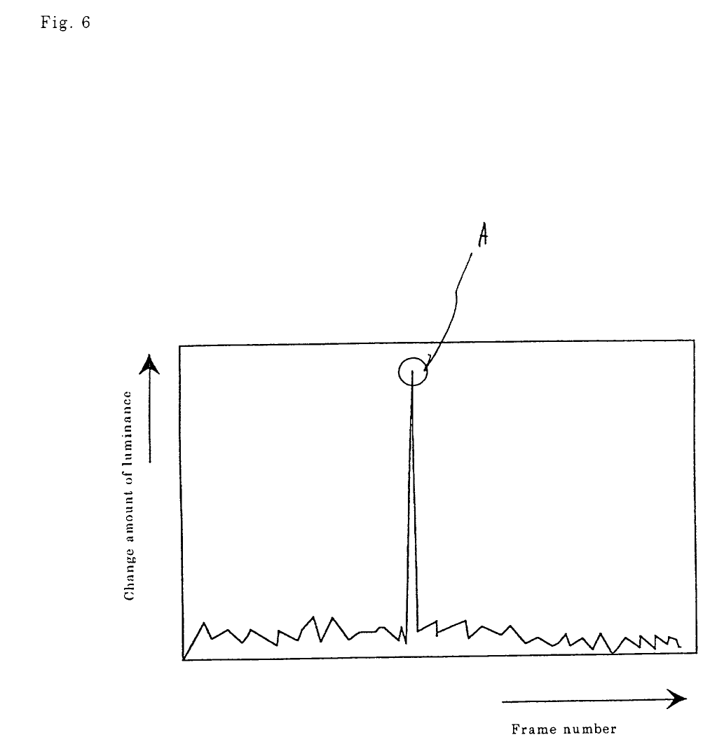

The change amount calculating method is not limited to the change amount of luminance, but the change amount of color difference signals may be also used. An example of graph showing change amount of luminance is given in FIG. 6.

In the absence of cut, images of two consecutive frames are very similar, the difference of luminance between frames in each divided region is small, and hence the change amount is small. In the presence of a cut, since the image contents are different in the divided regions of frames as shown in FIG. 5-b and FIG. 5-d, the difference of luminance between frames is large in each divided region, and the change amount is a large value as indicated by point A in FIG. 6. Thus, the change amount of luminance in the cut is outstanding, and therefore if the change amount exceeds a certain value (threshold), it is judged that a cut is present between the frames.

If it is judged that a cut is present, the frame number is transferred to the text file on the hard disk 107 (S7 in FIG. 4).

Next, the DV data of the present frame stored in the memory 104 is transferred and recorded in the hard disk 107 (S8 in FIG. 4).

This operation is repeated up to the final frame. S9 in FIG. 4 Thus, by decoding the video data in the DV data stored in the memory 104, cuts can be detected. By using the structure as shown in FIG. 3, regardless of the recorded content of the index code, simultaneous processing of transfer of the compressed motion picture data from the tape media 100 to the personal computer 102, and cut detection are realized.

Meanwhile, the DV data is not limited to the data shot by the DV camera, but, for example, one series of analog motion picture data containing plural cuts may be digitized, and encoded in the DV data format. In such a case, not only the index codes, but also, for example, the recorded time codes may not correspond to the cut position. Even in such data, in the structure in FIG. 3, the DV data can be decoded and the cut can be detected. That is, the cut can be detected without depending on the format of the encoded data. Incidentally, since the transferred compressed motion picture data is smaller in data quantity as compared with non-compressed motion picture data, simultaneous processing of data transfer and cut detection can be realized at high speed.

Moreover, by simultaneous processing of data transfer and cut detection, when data transfer to the personal computer is over, the user can immediately start next job such as nonlinear editing. At this time, by referring to the frame number of the cut recorded already in the text file, an arbitrary video clip can be accessed randomly for reproduction, or the sequence of video clips can be changed.

(Embodiment 3)

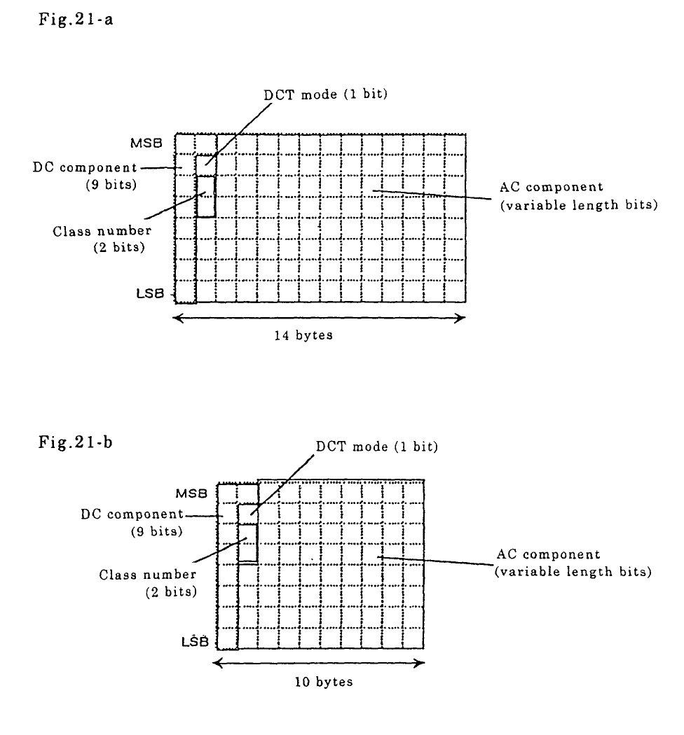

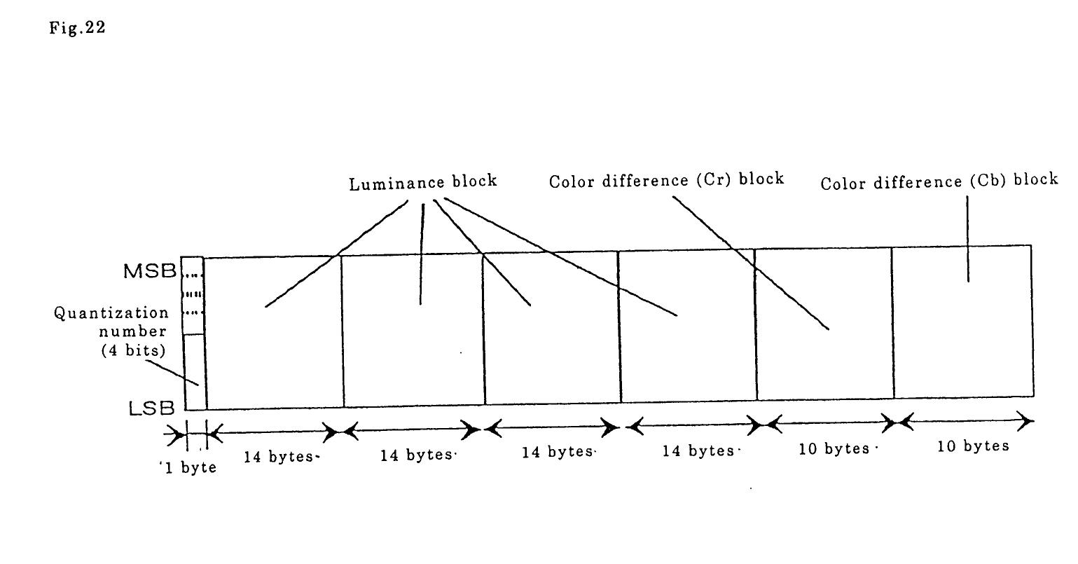

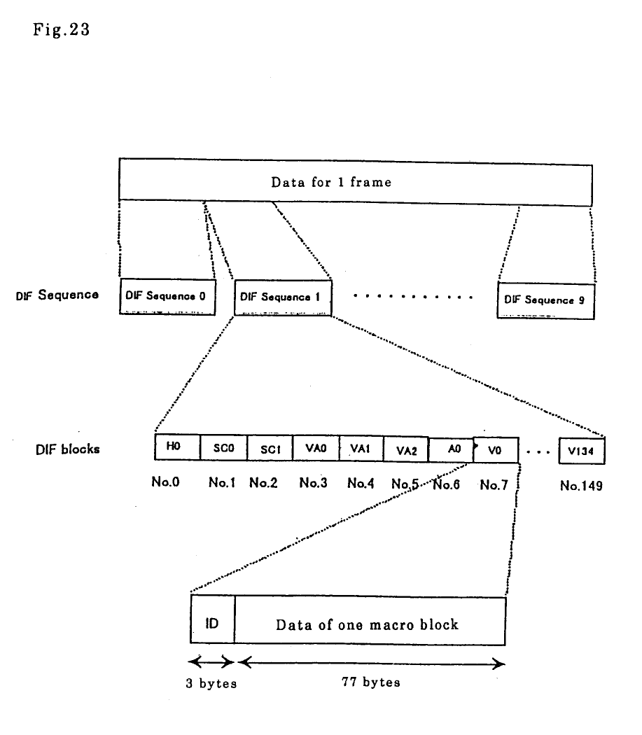

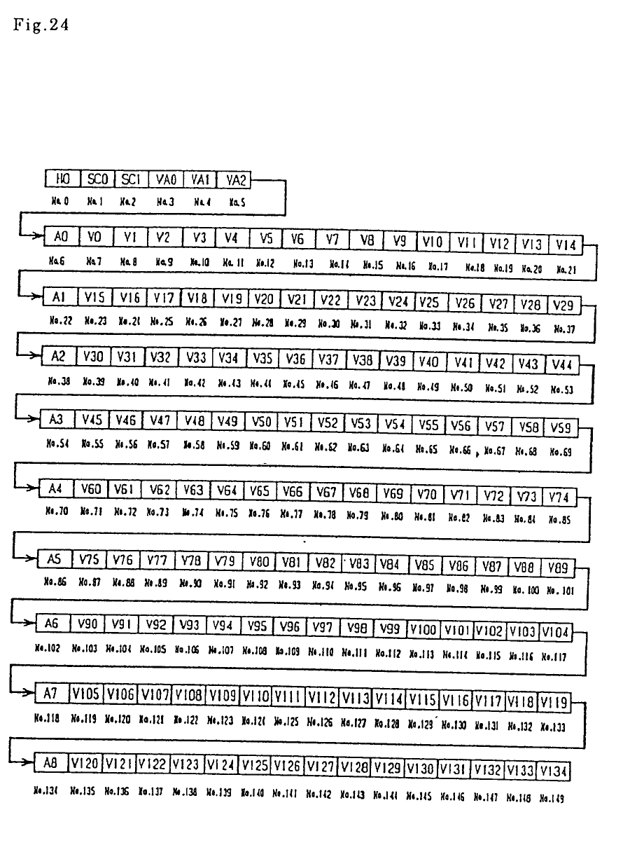

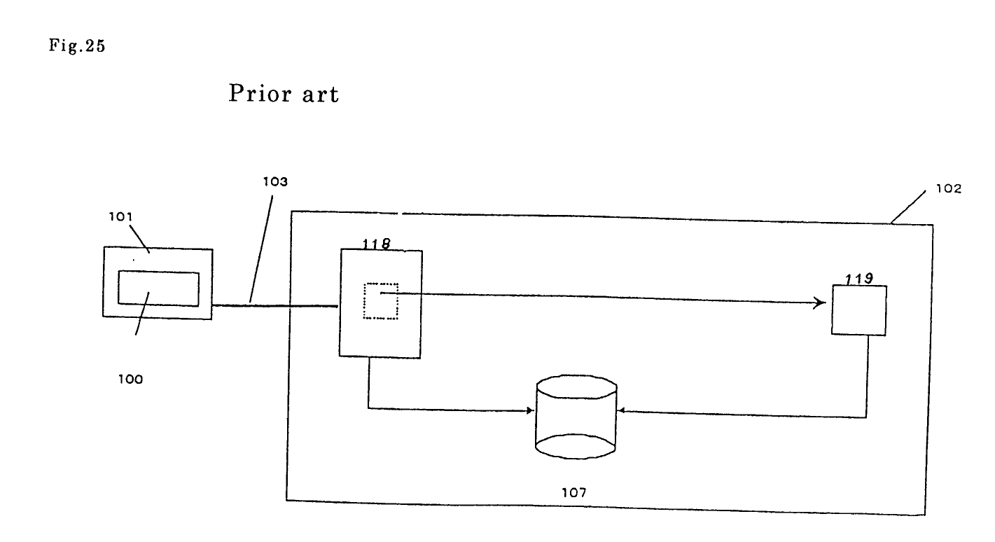

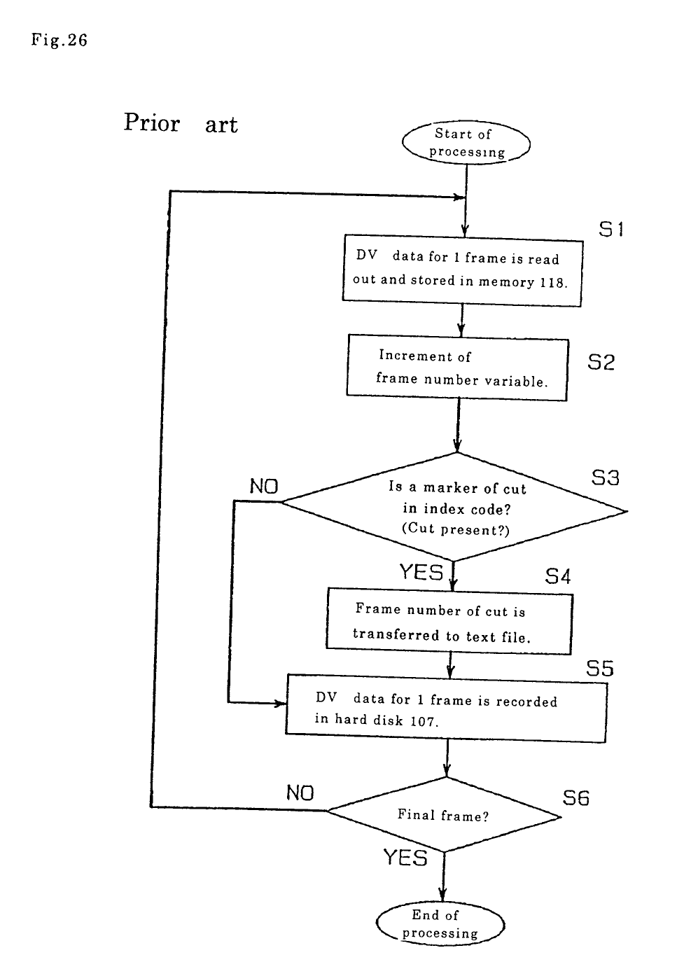

In embodiment 2 of the invention above, the DV data stored in the memory 104 in FIG. 3 is decoded, and the cut is detected, and as explained below, embodiment 3 of the invention comprises specific position data comparing means for directly comparing specific position data mentioned later without decoding the DV data. As shown in FIG. 23, the DV data of one frame is composed of DIF blocks of fixed length and fixed number. In one DIF block of DV data, as shown in FIG. 22, data of one compressed macro block is recorded. A compressed block which is a constituent element of compressed macro block is composed as shown in FIG. 21-a and 21-b. Herein, the DC component data is one of specific position data recorded in a specified position. That is, in the DV data of each frame, the DC component is recorded in a specified position, and the recording position is not changed depending on the images. In other words, the DC components are always recorded at the same position in all frames. Such data not changed the recorded position in the frame regardless of the images is called the specific position data. The specific position data includes, aside from the DC component, the class number and DCT mode existing in each block (see FIG. 21-a and 21-b), and quantization number existing in each macro block (see FIG. 22). Those which are not specific position data include AC components. The recording region of AC component data is fixed, that is, 100 bits in the case of luminance block, and 68 bits in the case of color difference block, and is recorded in the region after the class number as shown in FIG. 21-a and 21-b. However, since the AC component data is coded by variable length coding, the width of the range of recording this compressed AC component data in the recording region differs with each image. That is, the recording position of AC component data varies in each frame.

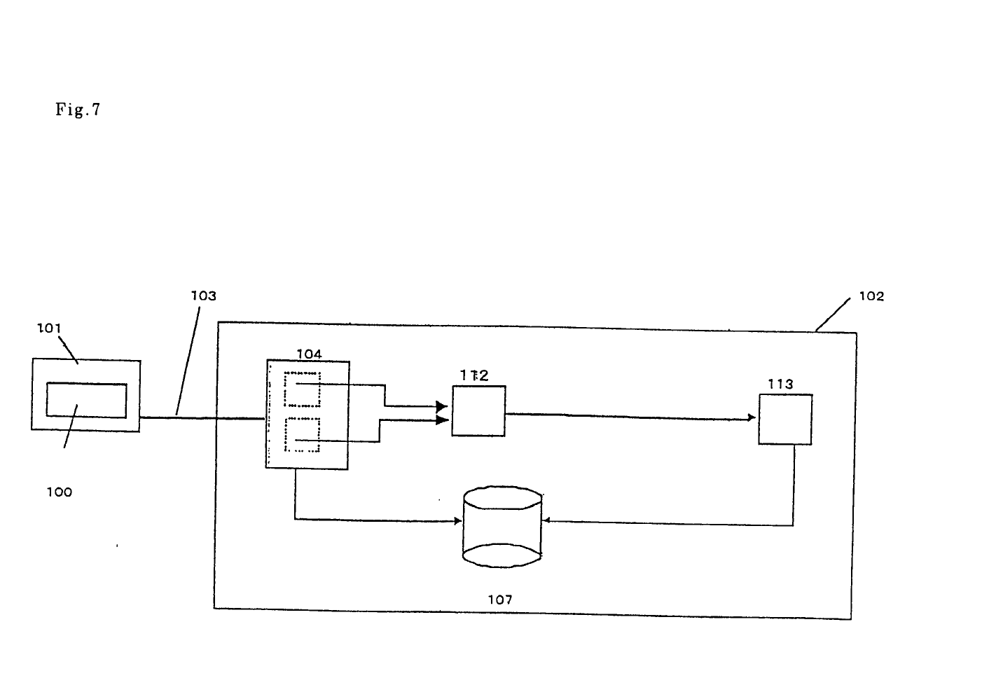

FIG. 7 is a structural diagram of an apparatus for detection of cut in compressed motion picture data in embodiment 3 of the invention. In FIG. 7, reference numeral 112 is DC component comparing means which is one of specific position data comparing means for comparing specific position data mutually between frames stored in the memory 104.

Reference numeral 113 is cut judging means for controlling the frame numbers of DV data stored in the memory 104, judging presence or absence of cut by using the result of comparison by the DC component comparing means 112, and transferring the frame number of the cut, to the hard disk 107 if the cut is present. Description of same reference numerals as in FIG. 1 is omitted.

In this embodiment 3, the DC component comparing means 112 and cut judging means 113 are composed of the software.

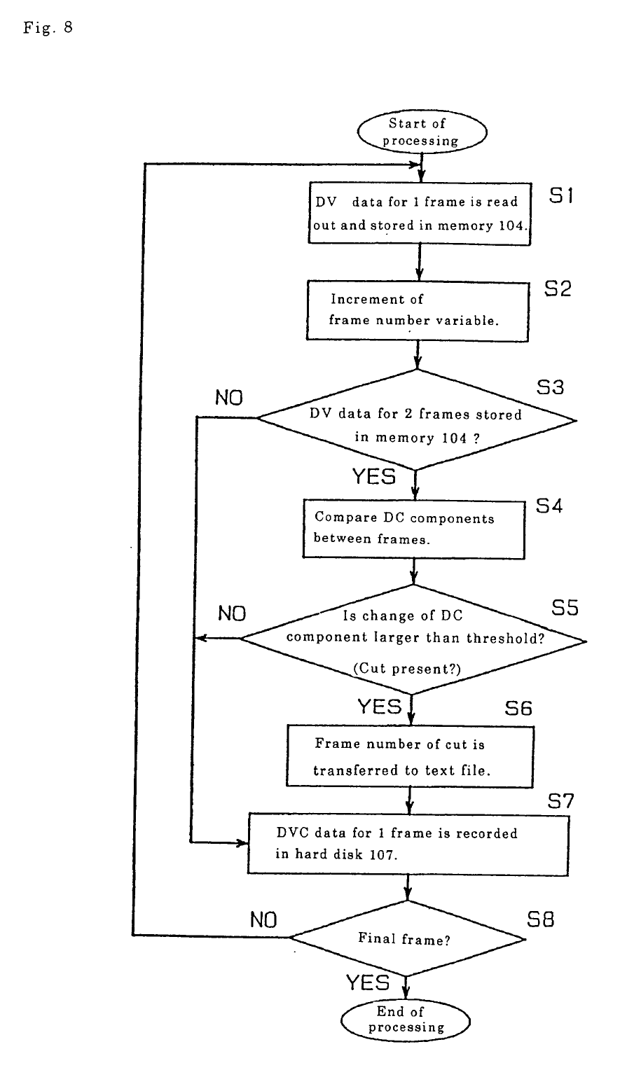

FIG. 8 shows the flow of operation of the apparatus for detection of cut in compressed motion picture data in embodiment 3 of the invention. The operation of the apparatus for detection of cut in compressed motion picture data in embodiment 3 of the invention is described below while referring to FIG. 7 and FIG. 8.

DV data for one frame is read out from the tape media for DV 100, and is stored as DV data of present frame in the memory 104 in the personal computer 102 through the IEEE1394 cable 103 (S1 in FIG. 8).

At this time, the cut judging means 113 increases the frame number variable by one(S2 in FIG. 8). It is judged whether DV data of two frames, that is, the present frame and preceding frame, are stored in the memory 104 or not (S3 in FIG. 8).

When the DV data of only one frame is stored, the DV data is recorded in the hard disk 107 (S7 in FIG. 8). When DV data for two frames are stored, DC components which are specific position data in each frame are compared between frames (S3 in FIG. 8). The DC components are values corresponding to the average of luminance or color difference of blocks, and same as in embodiment 2, the image is divided as shown in FIG. 5-b and FIG. 5-d, and the difference of DC components of blocks corresponding to the preceding frame and present frame is determined, and the sum of differences of DC components is determined in each divided region, which is obtained as the difference of DC components in each region. Next, the sum of absolute values of differences of DC components in all divided regions is determined, which is obtained as the change amount of DC components.

When the change amount of DC components is larger than a predetermined threshold, it is judged that a cut is present.

In the above description, the sum of absolute values of differences of all divided regions is determined, after dividing a frame into several regions, and said sum makes the difference between frames. That is a purpose to emphasize a individual change of each region between frames.

It is also another way that differences of DC component through a frame are summed and the absolute value of said summed value makes a difference between frames, without any dividing a frame. However, in this cut, when a big building is in a right half of a scene in a preceding frame and a similar building is in a left half of a scene in the present frame, a sum of differences of all DC component between the present frame and the preceding frame is small, and it is hard to detect cut at the point between the present frame and the preceding frame. To avoid such a problem, it is important to emphasize a difference of each divided region between two frames, after dividing a frame into several regions.

To obtain the value of DC component of each block, the first nine bits in the block are read out by accessing to the beginning address of the compressed block directly. (see FIG. 21-a and 21-b) Herein, when the change amount of DC components is larger than the predetermined threshold, it is judged that a cut is present (S5 in FIG. 8). This is similar to the point A in FIG. 6 relating to embodiment 2, that is, the presence or absence of cut is detected by making use of the characteristic that the change amount of the DC component is outstanding at the cut position. When judged that cut is absent, the DV data of the present frame in the memory 104 is recorded in the hard disk 107 (S7 in FIG. 8).

If it is judged that a cut is present, the frame number is transferred to the text file on the hard disk 107 (S6 in FIG. 8).

Next, the DV data of the present frame stored in the memory 104 is transferred and recorded in the hard disk 107 (S7 in FIG. 8).

This process is repeated up to the final frame. (S8 in FIG. 8)

Thus, by using DC components which are specific position data, cuts can be detected. By using the structure as shown in FIG. 7, regardless of the recorded content of the index code, simultaneous processing of transfer of the compressed motion picture data from the tape media 100 to the personal computer 102, and cut detection are realized.

Meanwhile, the DV data is not limited to the data taken by the DV camera, but, for example, one series of analog motion picture data containing plural cuts may be digitized, and encoded in the DV data format. In such a case, not only the index codes, but also, for example, the recorded time codes may not correspond to the cut position. Even in such data, in the structure in FIG. 7, the cut can be detected by using DC components. Incidentally, since the transferred compressed motion picture data is smaller in data quantity as compared with non-compressed motion picture data, simultaneous processing of data transfer and cut detection can be realized at high speed.

Moreover, by simultaneous processing of data transfer and cut detection, when data transfer to the personal computer is over, the user can immediately start next job such as nonlinear editing. At this time, by referring to the frame number of the cut recorded already in the text file, an arbitrary video clip can be accessed randomly for reproduction, or the sequence of video clips can be changed.

In embodiment 2, since cuts are detected after completely decoding the DV data, it requires the decoding means 108 for decoding and the decoded video data memory 109 for storing the motion picture data. In this embodiment 3, since cuts are detected by using the change amount of DC component data which are recorded at a specific position, the DC components can be read out only by is simple processing of accessing the beginning address of the block and reading out the first nine bits, which can be easily realized by the software. It hence does not require decoding means 108 and decoded video data memory 109, and the cost can be saved. Moreover, it does not require series of processing for decoding such as reading of AC components, inverse quantizing, and inverse DCT, so that high speed processing may be realized. Since the AC component is a variable length code, reading of AC component is different from reading of value of specified fixed length by accessing the beginning address of the block as in the reading of specific position data, but it is necessary to repeat decoding process of the variable length code of AC components gradually from the beginning, and the processing quantity is tremendous. Besides, the inverse quantizing and inverse DCT need an enormous quantity of product-sum operation. On the contrary, such huge processing, in this embodiment 3 for detecting cuts while reading out DC component data which are specific position data, it is possible to detect cuts at high speed, following up the speed to transfer the data from the tape media 100 to the personal computer 102, even in the case of high speed transfer of four times or five times of the ordinary reproduction speed of DV data.

(Embodiment 4)

Same as DC components of DCT coefficients in embodiment 3, the class number set in each block, and the quantization number set in each macro block are specific position data recorded in fixed positions in the frame (see FIG. 21-a and 21-b, FIG. 22), and cuts can be detected by comparing these values between the frames. High speed processing is possible same as when using DC components.

Embodiment 4 of the invention is described below while referring to the drawings.

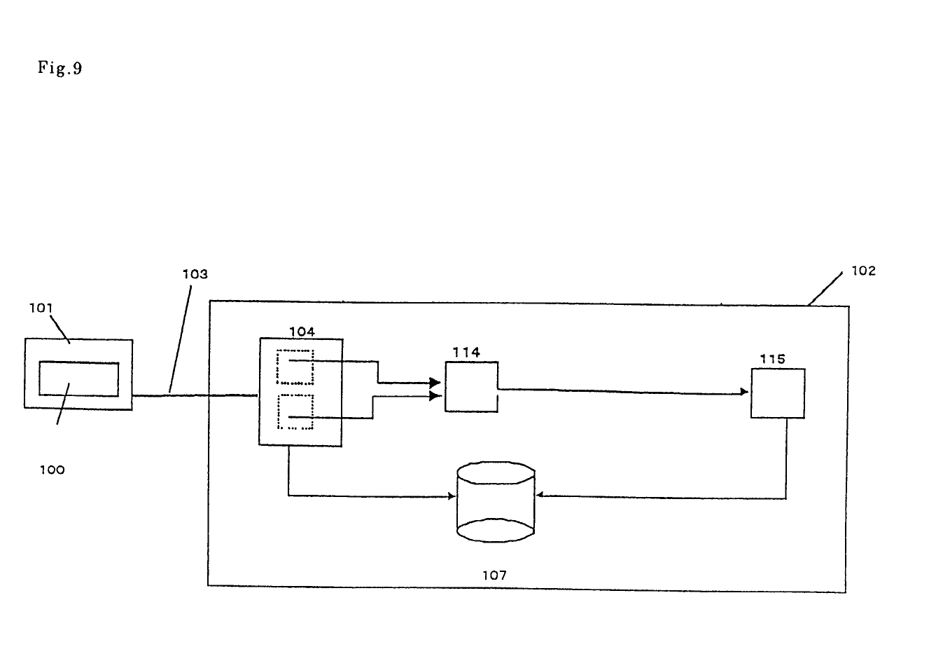

FIG. 9 is a structural diagram of an apparatus for detection of cut in compressed motion picture data in embodiment 4 of the invention. In FIG. 9, reference numeral 114 is class number comparing means which is one of specific position data comparing means for comparing specific position data mutually between frames stored in the memory 104, and 115 is cut judging means for controlling the frame numbers of DV data stored in the memory 104, judging presence or absence of cut by using the result of comparison by the class number comparing means 114, and transferring the frame number of the cut to the hard disk 107 if the cut is present. Description of same reference numerals as in FIG. 1 is omitted.

In this embodiment 4, the class number comparing means 114 and cut judging means 115 are composed of the software.

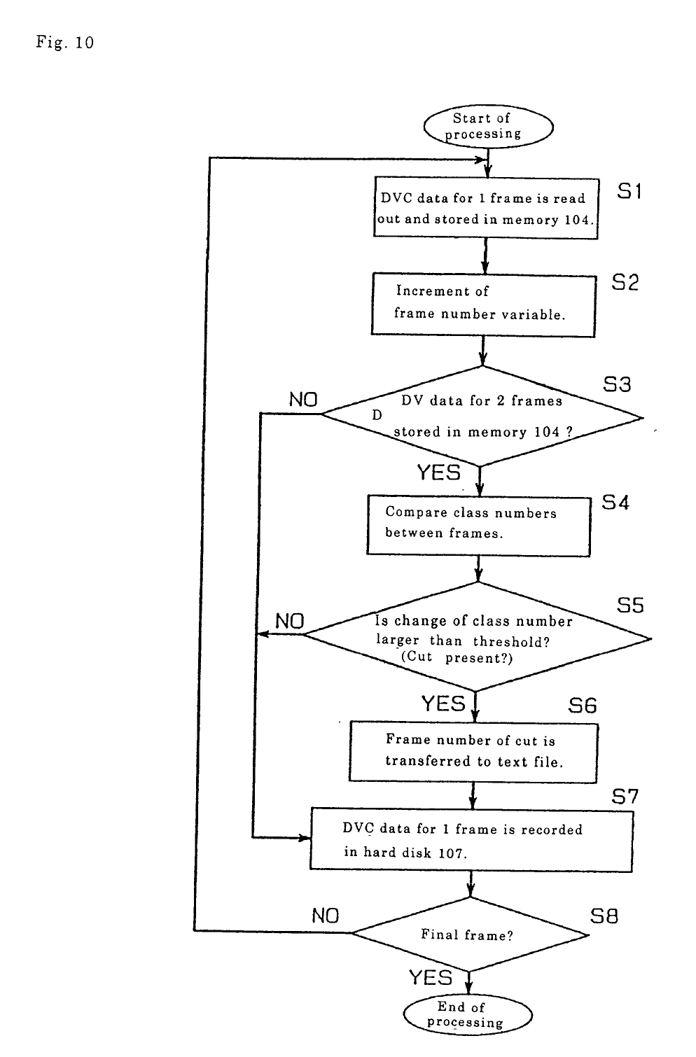

FIG. 10 shows the flow of operation of the apparatus for detection of cut in compressed motion picture data in embodiment 4 of the invention. The operation of the apparatus for detection of cut in compressed motion picture data in embodiment 4 of the invention is described below while referring to FIG. 9 and FIG. 10.

DV data for one frame is read out from the tape media for DV 100, and is stored as DV data of present frame in the memory 104 in the personal computer 102 through the IEEE1394 cable 103 (S1 in FIG. 10).

At this time, the cut judging means 115 increases the frame number variable by one(S2 in FIG. 10). It is judged if DV data of two frames, that is, the present frame and preceding frame, are stored in the memory 104 or not (S3 in FIG. 10). When DV data for two frames are stored, the class numbers which are specific position data in frame are compared between frames (S4 in FIG. 10).

When DV data for only one frame is stored in the memory 104, the DV data is recorded in the hard disk 107. (S7 in FIG. 10).

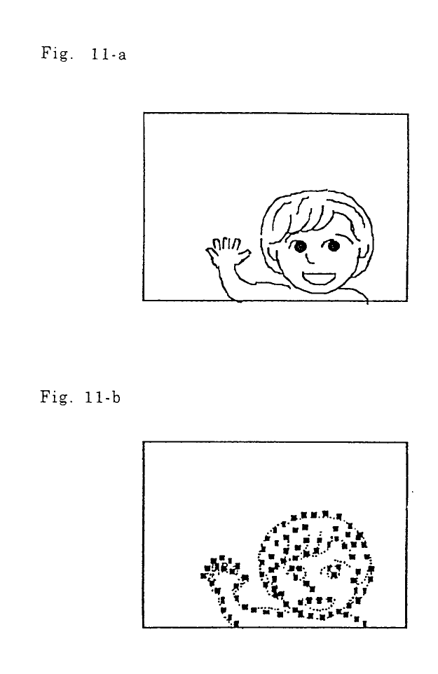

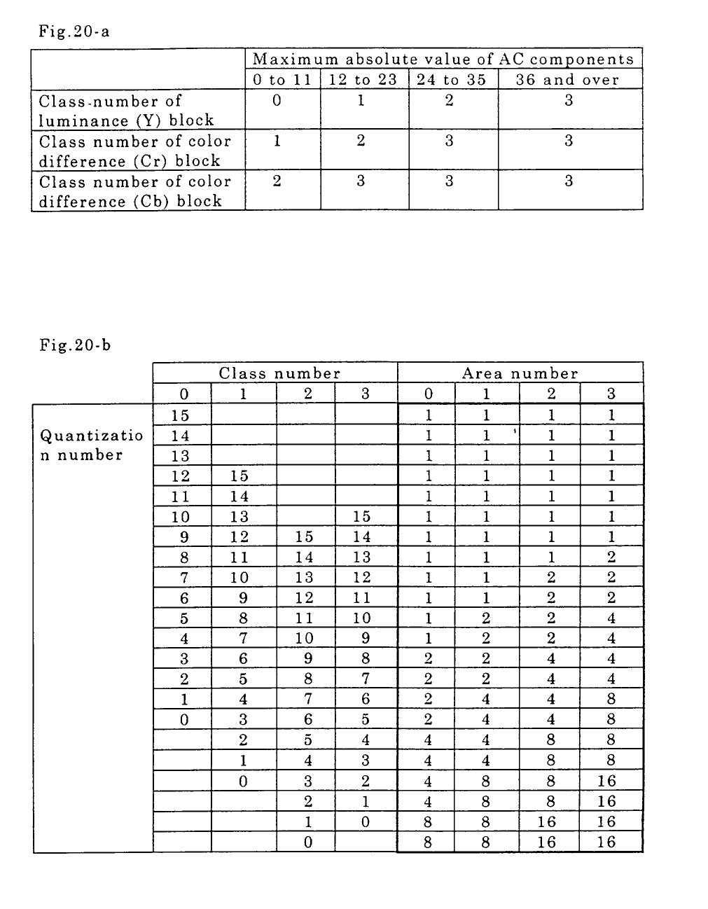

As shown in FIG. 20-a, since the class number is the value determined from the maximum value of the absolute value of the AC component in each block, in the example image in FIG. 11-a, the value of class number is large in complicated portion, such as human face contour or hair. The complicated portion is indicated by dark dots in FIG. 11-b. The monotonous portion such as the background is small in the class number, which corresponds to the white area in FIG. 11-b. Thus, features of the image are reflected in the class number.

When the change amount of class number is larger than a predetermined threshold, it is judged that a cut is present (S5 in FIG. 10).

When the change amount of class number is smaller than the threshold, the DV data of the present frame stored in the memory 104 is recorded in the hard disk 107 (S7 in FIG. 10).

If it is judged that a cut is present, the frame number is transferred to the text file on the hard disk 107 (S6 in FIG. 10).

Next, the DV data of the present frame stored in the memory 104 is transferred and recorded in the hard disk 107 (S7 in FIG. 10).

This process is repeated up to the final frame. (S8 in FIG. 10)

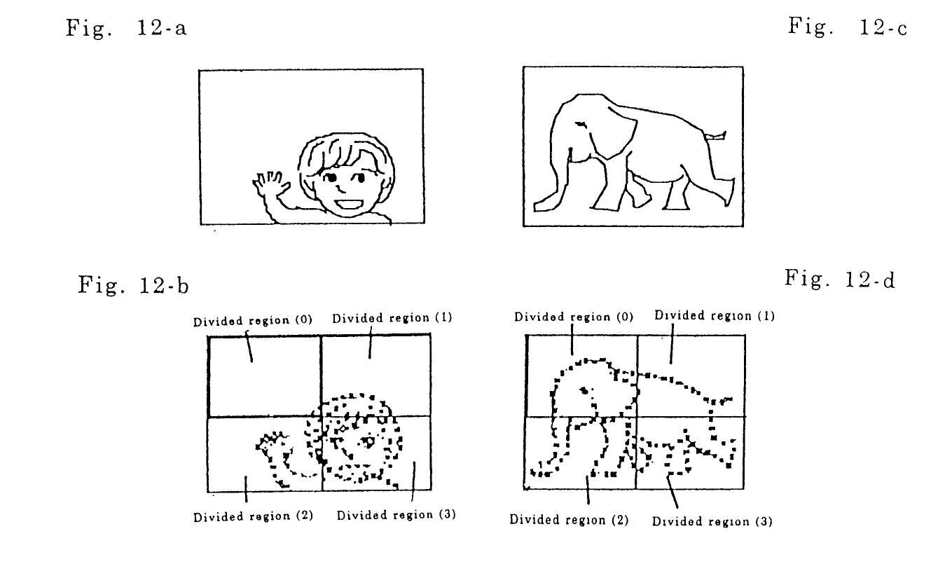

An example of determining the change amount of class number is shown in FIG. 12-a, FIG. 12-b, FIG. 12-c, and FIG. 12-d. The original pictures for determining the class number are shown in FIG. 12-a and FIG. 12-c. As shown in FIG. 12-b and FIG. 12-d, the image is divided, and the difference of class numbers of corresponding blocks of the preceding frame and present frame is determined, and the sum of differences is determined in each divided region, which is obtained as the difference of class number in each divided region. Further, the sum of absolute values of differences of class number in all divided regions is determined, which is obtained as the change amount of the class number of the frame.

In the above description, the sum of absolute values of differences of all divided regions is determined, after dividing a frame into several regions, and said sum makes the difference between frames. That is a purpose to emphasize a individual change of each region between frames.

It is also another way that differences of class number through a frame are summed and the absolute value of said summed value makes a difference between frames, without any dividing a frame. However, in this cut, when a big building is in a right half of a scene in a preceding frame and a similar building is in a left half of a scene in the present frame, a sum of differences of all class numbers between the present frame and the preceding frame is small, and it is hard to detect cut at the point between the present frame and the preceding frame. To avoid such a problem, it is important to emphasize a difference of each divided region between two frames, after dividing a frame into several regions.

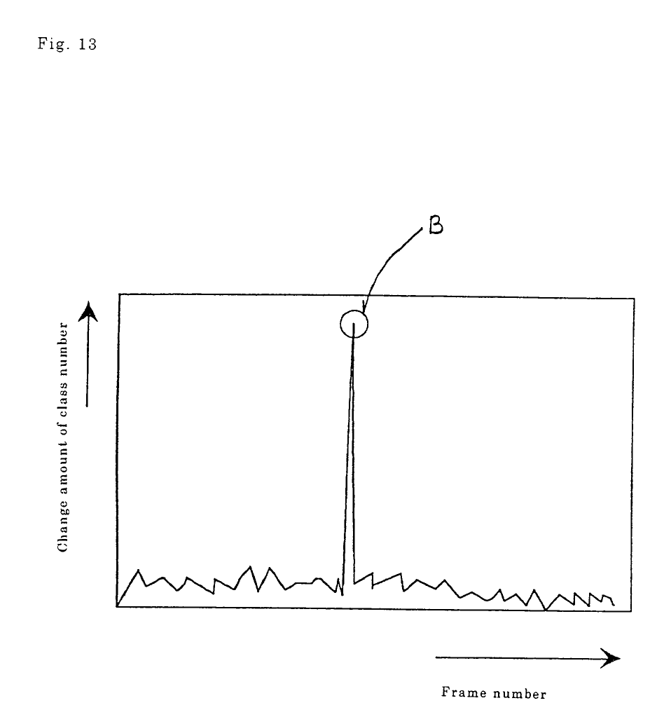

FIG. 13 shows a graph of change amount of class number.

In the absence of cut, images of two consecutive frames are very similar, the difference of class number between frames in each divided region is small, and hence the change amount of class number is small.

In the presence of a cut, since the image contents are different in the divided regions of frames as shown in FIG. 12-b and FIG. 12-d, the difference of class number between frames is large in each divided region, and the change amount of class number is a large value as indicated by point B in FIG. 13.

To read out the value of the class number of each block, by accessing directly to the beginning address of the block, the values of two bits at specified position in the block shown in FIG. 21-a and 21-b are read out. The difference of class number of corresponding blocks of the preceding and present frames is added in each region, which is obtained as the change amount of the class number in each region.

Thus, by using class numbers which are specific position data, cuts can be detected. That is, by using the structure as shown in FIG. 9, regardless of the recorded content of the index code, simultaneous processing of transfer of the compressed motion picture data from the tape media to the personal computer and cut detection are realized.

Meanwhile, the DV data is not limited to the data taken by the DV camera, but, for example, one series of analog motion picture data containing plural cuts may be digitized, and encoded in the DV data format. In such a case, not only the index codes, but also, for example, the recorded time codes may not correspond to the cut position. Even for such data described above, in the structure in FIG. 9, the cut can be detected by using class numbers. Incidentally, since the transferred compressed motion picture data is smaller in data quantity as compared with non-compressed motion picture data, simultaneous processing of data transfer and cut detection can be realized at high speed.

Moreover, by simultaneous processing of data transfer and cut detection, when data transfer to the personal computer is over, the user can immediately start next job such as nonlinear editing. At this time, by referring to the frame number of the cut recorded already in the text file, an arbitrary video clip can be accessed randomly for reproduction, or the sequence of video clips can be changed, so that editing in video clip units can be done efficiently.

In embodiment 2, since cuts are detected after completely decoding the DV data, it requires the decoding means 108 for decoding and the decoded video data memory 109 for storing the motion picture data. In this embodiment 4, since cuts are detected by using the change amount of class numbers between frames which are recorded at specific position, and the class numbers can be read out only by simple processing of accessing the beginning address of the block and reading out two bits at specified positions shown in FIG. 21-a and 21-b, which can be easily realized by the software. It hence does not require decoding means 108 and decoded video data memory 109 for storing the motion picture data, and the cost can be saved. Moreover, it does not require series of processing for decoding such as reading of AC components, inverse quantizing, and inverse DCT, so that high speed processing may be realized. Since the AC component is compressed by a variable length code, reading of AC component is different from reading of value of specified fixed length by accessing the beginning address of the block as in the reading of specific position data, but it is necessary to repeat decoding process of the variable length code of AC components gradually from the beginning, and the processing quantity is tremendous. Besides, the inverse quantizing and inverse DCT need an enormous quantity of product-sum operation. On the contrary, compared with such huge processing, in the apparatus for detection of cut in the compressed motion picture data in this embodiment 4 for detecting cuts while reading out class number data which are specific position data, it is possible to detect cuts at high speed, following up the speed to transfer the data from the tape media 100 to the personal computer 102, even in the case of high speed transfer of four times or five times of the ordinary reproduction speed of DV data.

Incidentally, the class number and quantization number are parameters for determining the quantization step. Between them, there is a relation as shown in FIG. 20, and further the quantization step can be easily obtained from the class number and quantization number, and the cut may be detected by using the result of comparison of the quantization step between frames.

The greater the class number, the more complicated is the image, which means that the quantity of data after compression is hardly become small. Since the DV data is fixed in the size of recording region in each block, it is necessary to compress the data in each block so as to finally settle in a determined recording region, and therefore, for the data hardly become small in data quantity after compression, a large value is used as quantization step.

Thus, the quantization step varies with the image same as the value of class number. That is, since the feature of the image is reflected also in the quantization step, it can be used in cut detection same as in class number.

The quantization number is also a parameter varying for the purpose that the size of the data quantity after compression may be a specified amount, and the feature of the image is reflected same as the quantization step, and hence it can be used in cut detection.

Meanwhile, the class number, quantization step, and quantization number are values related with compression of AC components of DCT coefficients, and are hence values relating with the complicatedness of image. More specifically, in the image shown in FIG. 11-a, the class number of the contour portion as indicated by dots in FIG. 11-b is a large value. In the foregoing embodiment 3, an example of detecting cuts by using DC components is shown, but when the DC components are used, if the luminance value is changed extremely in a series of scene free from cut, it may be judged that a cut is present in spite of cut-free data. Herein, such wrong detection of cut due to erroneous judgement is called excessive detection. For example, in a scene of lighting a lamp by a person, between the frames before and after lighting the lamp, the luminance difference in the lamp area is extremely large. As a result, it may lead to excessive detection. However, when detecting cuts by using class number, quantization step or quantization number, the shape of the lamp portion being lit is not extremely changed, and comparing with the case of using DC components, excessive detection due to effects of luminance change is less likely to occur. Of course, cuts may be detected by using the DC components together with class number, quantization number or quantization step. For example, when a scene of which a person wearing red dress is standing in a center is changed to a next scene of which a person wearing blue dress is standing in a center, since the existing position of the subject is not changed, the same contour is present in the positions corresponding to two consecutive frames. Hence, large change is not detected between the frames before and after the scene in the class number, quantization step or quantization number, and detection failure of cut may occur. However, a large change occurs in the DC component of color difference. Therefore, detection of high precision is realized by combining the detection of cut by the class number, quantization step or quantization number, and detection of cut by DC component mentioned in embodiment 3 of the invention.

(Embodiment 5)

Embodiment 5 of the invention is described below while referring to the drawings.

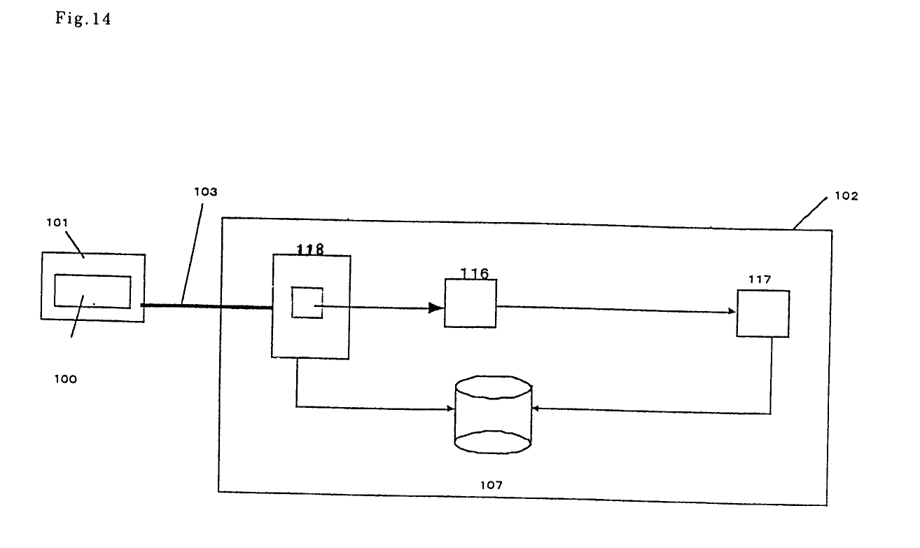

FIG. 14 is a structural diagram of an apparatus for detection of cut in compressed motion picture data in embodiment 5 of the invention. In FIG. 14, the memory 118 in the personal computer 102 is fourth random access media for temporarily storing DV data for one frame entered through the IEEE1394 cable 103. Reference numeral 116 is a DCT mode counter for counting the number of blocks of which flag showing the DCT mode is 1, out of the data for one frame stored in the memory 118.

Reference numeral 117 is cut judging means for controlling the frame number of DV data stored in the memory 118, judging presence or absence of cut by using the result of DCT mode counter 116, and transferring the frame number of cut to the hard disk 107 if cut is present. Description of same reference numerals as in FIG. 1 is omitted.

In this embodiment 5, the DCT mode counter 116 and cut judging means 117 are composed of software.

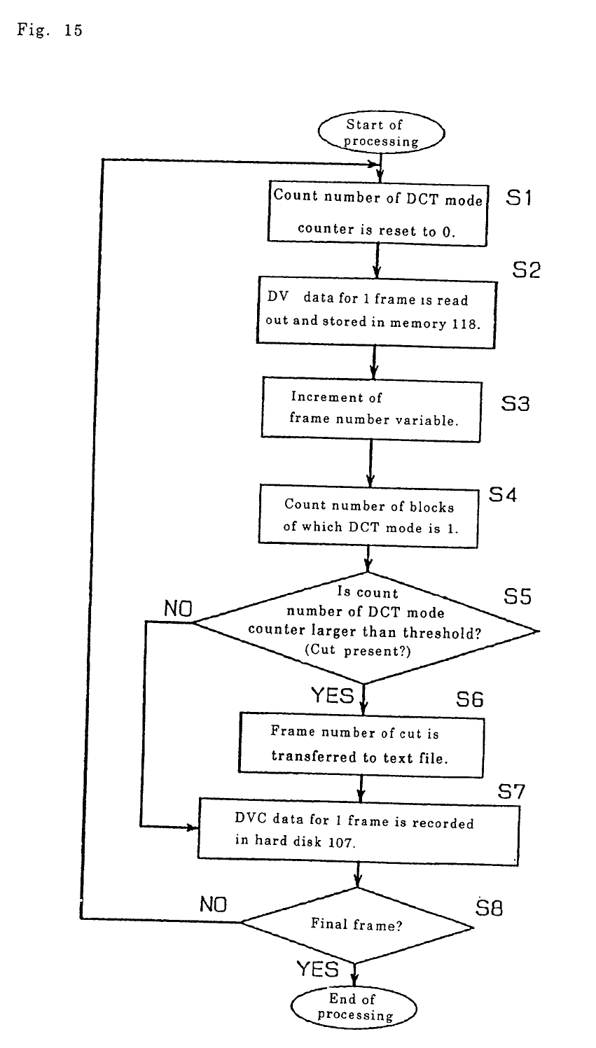

FIG. 15 shows the flow of operation of the apparatus for detection of cut in compressed motion picture data in embodiment 5 of the invention. The operation of the apparatus for detection of cut in compressed motion picture data in embodiment 5 of the invention is described below while referring to FIG. 14 and FIG. 15.

First, the count number of the DCT mode counter 116 is reset to 0 (S1 in FIG. 15). Then the DV data for one frame is read out from the tape media for DV 100, and is stored in the memory 118 in the personal computer 102 through the IEEE1394 cable 103 (S2 in FIG. 15).

At this time, the cut judging means 117 increases the frame number variable by one(S3 in FIG. 15).

Reading out the value of flag showing DCT mode of each block in the frame, the number of blocks of which value of the flag is 1 is counted (S4 in FIG. 15).

To read out the value of the flag expressing the DCT mode of each block, the value of one bit at specified position in the block shown in FIG. 21-a and 21-b is read by accessing to the beginning address of the block directly.

Consequently, comparing a predetermined threshold and the count number of the DCT mode counter 116 in the cut judging means 117, when the count number is larger than the threshold, it is judged that a cut is present (S5 in FIG. 15).

When present of cut is judged, the frame number is transferred to the text file on the hard disk 107 (S6 in FIG. 15).

Then the DV data stored in the memory 118 is transferred and recorded in the hard disk 107 (S7 in FIG. 15).

This operation is repeated up to the final frame. (S8 in FIG. 15)

The proof to be able to detect the cut by using the value of the output of the DCT mode counter 116 is explained below by showing the relation of DCT mode and image.

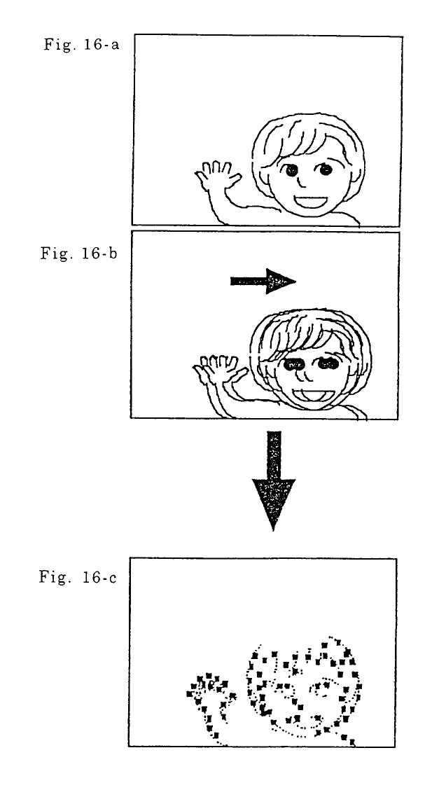

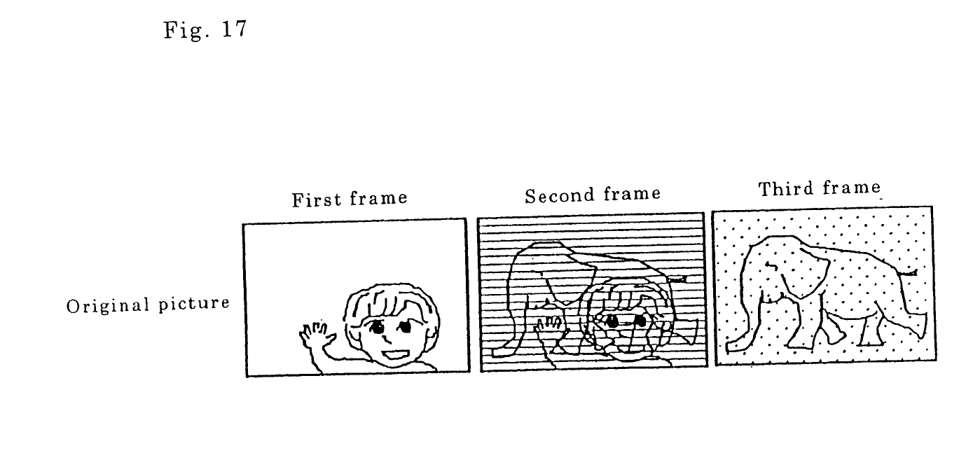

To begin with, the relation of the DCT mode and image is explained by referring to FIG. 16-a, 16-b, 16-c and FIG. 17.

In the DCT in compression method of DV, two modes are prepared for suppressing the degradation of picture quality after compression, one is called an 8-8 DCT mode, and other is called a 2-4-8 DCT mode. These two modes are used adaptively with different DCT mode flag respectively. When the difference of values of pixels in blocks corresponding to odd field and even field in a same frame is large, the value of the flag of DCT mode is 1, and the 2-4-8 DCT is performed. When the difference of values of pixels in blocks corresponding to odd field and even field in a same frame is small, the value of the flag of DCT mode is 0, and the 8-8 DCT is performed.

For example, when the motion of the subject is fast, the 2-4-8 DCT is carried out, and when the motion is slow such as in still picture, the 8-8 DCT is carried out.

FIG. 16-a, FIG. 16-b, and FIG. 16-c show DCT modes in which the subject is moving to the right. FIG. 16-a shows a frame in still state. FIG. 16-b shows that the difference of values of pixels corresponding to odd field and even field increases when the subject moves to the right. Such block is the dark block in FIG. 16-c, and the flag of the DCT mode is 1. In this example, since the background is not changed notably, the flag of the DCT mode is 0, and the block in which the flag of DCT mode is 1 is only a part of the entire image.

Next, FIG. 17 shows an example of a cut changing in scene between an odd field and an even field in a certain frame (hereinafter called a field mixture cut). In FIG. 17, the left figure represents a first frame, the middle figure is a second frame, and the right figure is a third frame. There is a scene change between the odd field and even field of the second frame, and the second frame is a mixture of the first frame and third frame, which is a field mixture cut.

In such a case, many similar elements are contained in the first frame and second frame, and the difference of values of pixels corresponding to the first frame and second frame is not such a large value. Hence, it is hard to detect the field mixture cut by using the difference value between the first frame and the second frame. It holds true also between the second frame and the third frame.

On both sides of the second frame, the difference value between the first frame and the third frame is large, and the field mixture cut can be detected by using said difference values, but to obtain the difference value of the first frame and the third frame, it requires a memory for storing the first frame and the third frame and the apparatus cost cannot be lowered.

However, it is characteristic that the DCT mode is 1 in almost all blocks in the entire image of the second frame. By making use of this feature, after counting the number of blocks in which the DCT mode is 1 in each frame, the field mixture cut can be detected by using the count number.

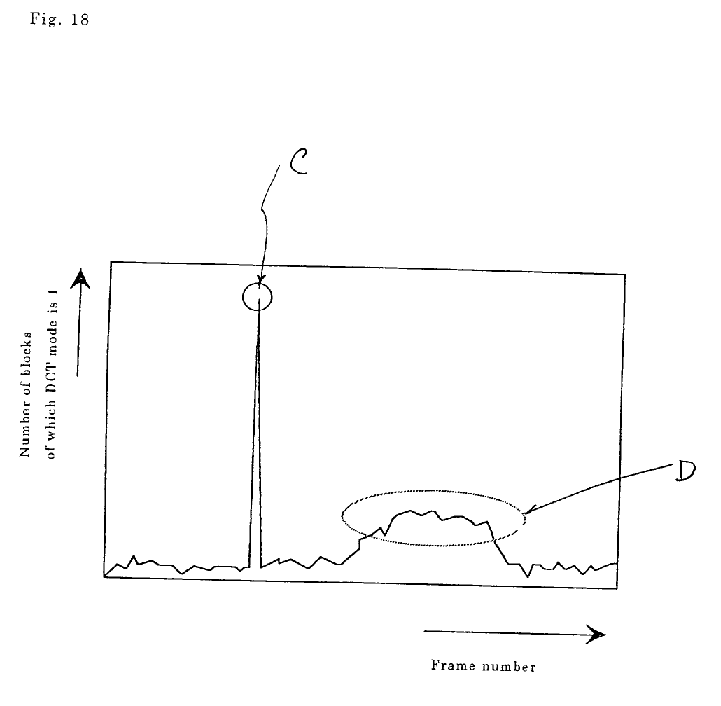

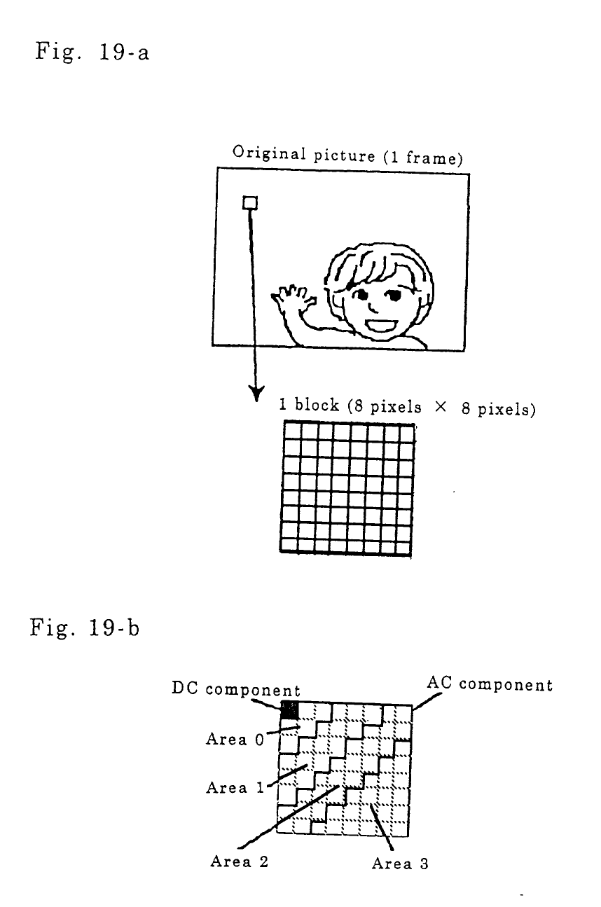

FIG. 18 shows an example of counting the number of blocks in which the flag of DCT mode is 1, in every frame. Point C in FIG. 18 is a field mixture cut, and the number of blocks of which the flag of DCT mode is 1 is extremely large. Point C in FIG. 18 is a region of large motion of subject. At point D, the number of blocks in which the flag of DCT mode is 1 is slightly large too, but the number of blocks in which the flag of DCT mode is 1 is only a very small part of the entire picture in the case of merely moving of the subject as shown in FIG. 16-b, and it is not an extremely large number as in the field mixture cut, and hence excessive detection does not occur.

Owing to such feature, by counting the number of blocks in which the flag of DCT mode of each frame is 1, the field mixture cut can be detected.

According to this method, it is not necessary to use the difference number of the first frame (left figure) and third frame (right figure), it does not require memory for storing the first frame and third frame, so that the apparatus cost can be lowered.

Thus, by using the DCT mode, the field mixture cut can be detected. By using the structure as shown in FIG. 14, regardless of the recorded content of the index code, simultaneous processing of transfer of the compressed motion picture data from the tape media 100 to the personal computer 102, and cut detection are realized.

Meanwhile, the DV data is not limited to the data taken by the DV camera, but, for example, one series of analog motion picture data containing plural cuts may be digitized, and encoded in the DV data format. In such a case, not only the index codes, but also, for example, the recorded time codes may not corresponds to the cut position. Even in such data, in the structure in FIG. 14, the cut can be detected by using the DCT mode. Incidentally, since the transferred compressed motion picture data is smaller in data quantity as compared with non-compressed motion picture data, simultaneous processing of data transfer and cut detection can be realized at high speed.

Moreover, by simultaneous processing of data transfer and cut detection, when data transfer to the personal computer is over, the user can immediately start next job such as nonlinear editing. At this time, by referring to the frame number of the cut recorded already in the text file, an arbitrary video clip can be accessed randomly for reproduction, or the sequence of video clips can be changed, so that editing in video clip units can be done efficiently.

In embodiment 2, since cuts are detected after completely decoding the DV data, it requires the decoding means for decoding and the decoded video data memory. In this embodiment 5, cuts are detected by using the number of blocks in which the flag of the DCT mode is 1, and the flag of the DCT mode which is recorded at specific position can be read out only by simple processing of accessing the beginning address of the block and reading out one bit at specified positions shown in FIG. 21-a and 21-b, which can be easily realized by the software. It hence does not require decoding means and decoded video data memory, and the cost can be saved. Moreover, it does not require series of processing for decoding such as reading of AC components, inverse quantizing, and inverse DCT, so that high speed processing may be realized. Since the AC component is compressed by a variable length code, reading of AC component is different from reading of value of specified fixed length by accessing the beginning address of the block as in the reading of specific position data, but it is necessary to repeat decoding process of the variable length code of AC components gradually from the beginning, and the processing quantity is tremendous. Besides, the inverse quantizing and inverse DCT need an enormous quantity of product-sum operation. On the contrary, compared with such huge processing, in this embodiment 5 for detecting cuts by using the number of blocks in which the flag of the DCT mode is 1, it is possible to detect cuts at high speed, following up the speed to transfer the data from the tape media 100 to the personal computer 102, even in the case of high speed transfer of four times or five times of the ordinary reproduction speed of DV data in the data.

Incidentally, the cut may be detected by combining the DCT mode with DC component, class number, quantization number, or quantization step. When combining, it is possible to detect cut from compressed motion picture data containing both field mixture cut and ordinary cut other than field mixture cut.

In embodiment 1 through embodiment 5, the frame number of the cut is recorded in the text file in the hard disk 107, but not limited to this, it may be also recorded in other recording media, such as floppy disk and IC card.

According to the apparatus for detection of cut in compressed motion picture data of the invention, regardless of the recorded content of the index code, simultaneous processing of transfer of compressed motion picture data from the tape media to the personal computer and cut detection are enabled. Besides, since the transferred compressed motion picture data is smaller in data quantity as compared with non-compressed motion picture data, simultaneous processing of data transfer and cut detection can be realized at high speed.

Moreover, by simultaneous processing of data transfer and cut detection, when data transfer to the personal computer is over, the user can immediately start next job such as nonlinear editing. At this time, by referring to the frame number of the cut recorded already in the text file, an arbitrary cut can be accessed randomly for reproduction, or the sequence of cuts can be changed, so that editing in video clip units can be done efficiently.

What is claimed is:

1. An apparatus for detection of cut in compressed motion picture data comprising;
tape media compressed motion picture data reading means for reading out compressed motion picture data from tape media,
first random access media for storing compressed motion picture data read out from said tape media,
second random access media for recording compressed motion picture data stored in said first random access media,
compressed motion picture data transfer means for transferring the compressed motion picture data from said tape media compressed motion picture data reading means to said first random access media,
recorded time code comparing means for comparing recorded time codes in the compressed motion picture data in plural frames stored in said first random access media, and
cut judging means for judging presence or absence of cut by using the result of comparison.

2. An apparatus for detection of cut in compressed motion picture data comprising;
tape media compressed motion picture data reading means for reading out compressed motion picture data from tape media,
first random access media for storing said compressed motion picture data,
second random access media for recording compressed motion picture data stored in said first random access media,
compressed motion picture data transfer means for transferring the compressed motion picture data from said tape media compressed motion picture data reading means to said first random access media, and
cut judging means for judging presence or absence of cut by using the encoded video data in the compressed motion picture data transferred from said compressed motion picture data transfer means.

3. An apparatus for detection of cut in compressed motion picture data comprising;
tape media compressed motion picture data reading means for reading out compressed motion picture data from tape media,
first random access media for storing said compressed motion picture data reading out from the tape media,
second random access media for recording compressed motion picture data stored in said first random access media,
compressed motion picture data transfer means for transferring compressed motion picture data from said tape media compressed motion picture data reading means to said first random access media,
decoding means for decoding the compressed motion picture data of plural frames stored in said first random access media,
third random access media for storing said decoded video data,
decoded video data comparing means for comparing the decoded video data of plural frames stored in said third random access media, and
cut judging means for judging presence or absence of cut by using the result of comparison by said decoded video data comparing means.

4. An apparatus for detection of cut in compressed motion picture data of claim 2, wherein the cut judging means for judging presence or absence of cut by using the encoded data in said compressed motion picture data includes specific position data comparing means for comparing of data at specific position by counting from the beginning of each frame of said compressed motion picture data between frames, and cut judging means for judging presence or absence of cut by using the result of comparison by said specific position data comparing means.

5. An apparatus for detection of cut in compressed motion picture data comprising;
specific position data comparing means for comparing data at specific position by counting from the beginning of each frame of compressed motion picture data between frames, and
cut judging means for judging presence or absence of cut by using the result of comparison by said specific position data comparing means.

6. An apparatus for detection of cut in compressed motion picture data of claim 5, wherein data of DC components of orthogonal transform coefficient in said compressed motion picture data are compared by the specific position data comparing means.

7. An apparatus for detection of cut in compressed motion picture data of claim 5, wherein data of quantization step in said compressed motion picture data are compared by the specific position data comparing means.

8. An apparatus for detection of cut in compressed motion picture data of claim 5, wherein the compressed motion picture data is DV data, and data of class numbers in said DV data are compared by the specific position data comparing means.

9. An apparatus for detection of cut in compressed motion picture data of claim 5, wherein the compressed motion picture data is DV data, and data of quantization numbers in said DV data are compared by the specific position data comparing means.

10. An apparatus for detection of cut in compressed motion picture data of claim 5, wherein the specific position comparing means compares data of DC components of orthogonal transform in said compressed motion picture data between frames and also compares data of quantization steps between frames.

11. An apparatus for detection of cut in compressed motion picture data of claim 5, wherein the compressed motion picture data is DV data, and specific position data comparing means compares data of DC components of DCT coefficients in said DV data between frames, and compares class numbers between frames.

12. An apparatus for detection of cut in compressed motion picture data of claim 5, wherein the compressed motion picture data is DV data, and specific position data comparing means compares data of DC components of DCT coefficients in said DV data between frames, and compares data of quantization numbers between frames.

13. An apparatus for detection of cut in compressed motion picture data comprising
a counter for counting the number of blocks having predetermined DCT mode in DV data, and
cut judging means for judging presence or absence of cut by using the count number of said counter.
